(19) United States
(12) Patent Application Publication
(10) Pub. No.: US 2007/0251785 A1
(43) Pub. Date: Nov. 1, 2007

(54) REEL DEVICE WITH ILLUMINATING ELEMENT

(76) Inventor: Tom Chen, Gangshan Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/381,054

(22) Filed: May 1, 2006

(51) Int. Cl. H02G 11/02

(52) U.S. Cl. 191/12.2 R

(57) ABSTRACT

A reel device includes an extendible unit, a return spring for returning the extendible unit, an internal control unit, at least one cell, and an external control member. The extendible unit includes a wire. The internal control unit includes a fixed conductive member and a movable conductive member. The cell is electrically connected via the internal control unit to an end of the wire. An illuminating element is mounted in the external control member and electrically connected to the other end of the wire. The movable conductive member comes in contact with the fixed conductive member when the external control member is pulled outward and thus carries the wire outward, and the illuminating element is turned on.

### BACKGROUND OF THE INVENTION

1. Field of the Invention

The present invention relates to a reel device. More particularly, the present invention relates to a reel device having an illuminating element attached to an end of a wire for providing illumination when the wire is pulled outward.

2. Description of Related Art

U.S. Pat. No. 6,290,158 discloses a portable reel device comprising a housing, a reel axle mounted in the housing, a coil spring mounted in the reek axle, and a roll of pulling rope coiled between the housing and the reel axle. A pulling control member is mounted to an end of the pulling rope that is exposed to an exterior of the housing. A small object such as a key may be attached to the pulling control member.

When in use, a user pulls the pulling control member and thus pulls the pulling rope and the coil spring to a desired extent. When the pulling control member is released after use, the pulling control member and the pulling rope are returned to their initial position under the action of the coil spring. However, use of the object (such as a key) attached to the reel device is inconvenient when in the narrowed and dusky or dark environment.

### OBJECTS OF THE INVENTION

An object of the present invention is to provide a reel device with an illuminating element to provide illumination while using an object attached to the reel device.

Another object of the present invention is to provide a switch for the reel device to control on/off of the illuminating element.

### SUMMARY OF THE INVENTION

A reel device in accordance with the present invention comprises an extendible unit, a return spring for returning the extendible unit, an internal control unit, at least one cell, and an external control member. The extendible unit includes a wire. The internal control unit includes a fixed conductive member and a movable conductive member. The cell is electrically connected via the internal control unit to an end of the wire. An illuminating element is mounted in the external control member and electrically connected to the other end of the wire.

The movable conductive member comes in contact with the fixed conductive member when the external control member is pulled outward and thus carries the wire outward, and the illuminating element is turned on.

Preferably, the reel device further comprises a housing including a first compartment for receiving a positioning member and the return spring. The return spring is mounted between the positioning member and the extendible unit.

Preferably, the extendible unit comprises a rotational ring and a connecting ring. The return spring has an end attached to the rotational ring. The connecting ring is mounted around the rotational ring. The wire is wound around the connecting ring.

Preferably, the connecting ring comprises an annular board having at least two terminals electrically connected to an end of the wire.

Preferably, a circuit board is formed on an inner wall defining the first compartment of the housing. The circuit board includes at least two conductive rings respectively connected to the terminals for respective electrical connection with the cell and the illuminating element.

Preferably, the housing further comprises at least one second compartment for receiving the cell.

Preferably, the housing further comprises a third compartment for receiving the internal control unit.

Preferably, the first compartment is in communication with the third compartment via a channel through which the wire extends.

Preferably, at least one elastic element is mounted between an inner wall defining the third compartment and the movable conductive member of the internal control unit.

Preferably, the internal control unit further comprises an abutting member having an inner wall to which the external control member abuts and along which the movable conductive member moves.

Preferably, the external control member is conic and has a maximum diameter larger than an inner diameter of the abutting member.

Preferably, each of the movable conductive member and the fixed conductive member includes a flange for mutual electrical connection.

Preferably, the reel device further includes a switch for controlling on/off of the illuminating element.

Other objects, advantages and novel features of this invention will become more apparent from the following detailed description when taken in conjunction with the accompanying drawings.

### BRIEF DESCRIPTION OF THE DRAWINGS

FIG. 1 is a sectional view of a reel device in accordance with the present invention;

FIG. 2 is another sectional view of the reel device in accordance with the present invention;

FIG. 3 is a schematic circuitry diagram of the reel device in accordance with the present invention; and

FIG. 4 is a view similar to FIG. 1, illustrating use of the reel device.

### DETAILED DESCRIPTION OF THE PREFERRED EMBODIMENT

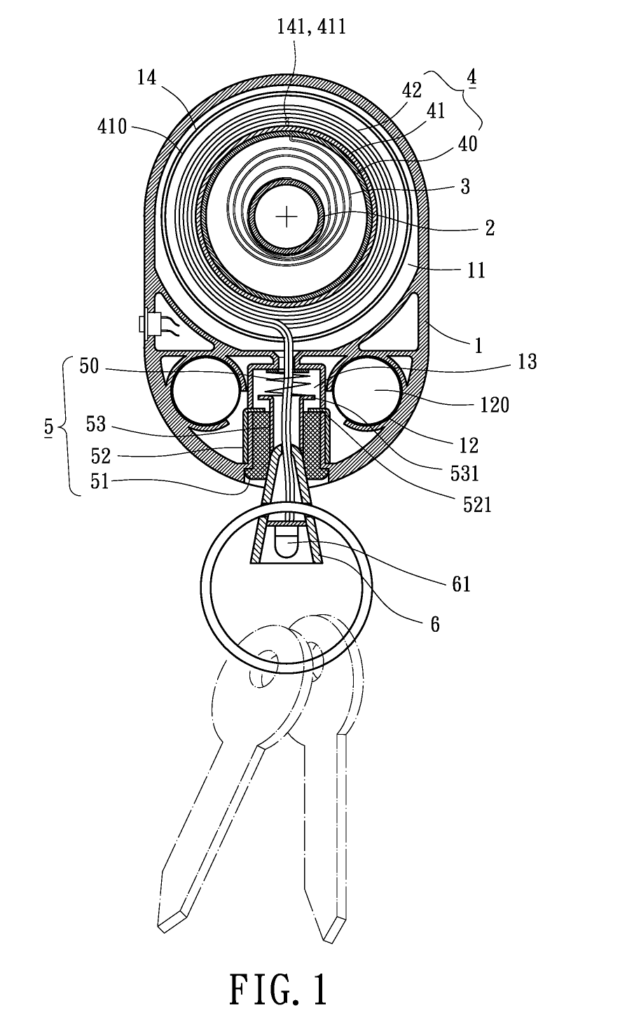

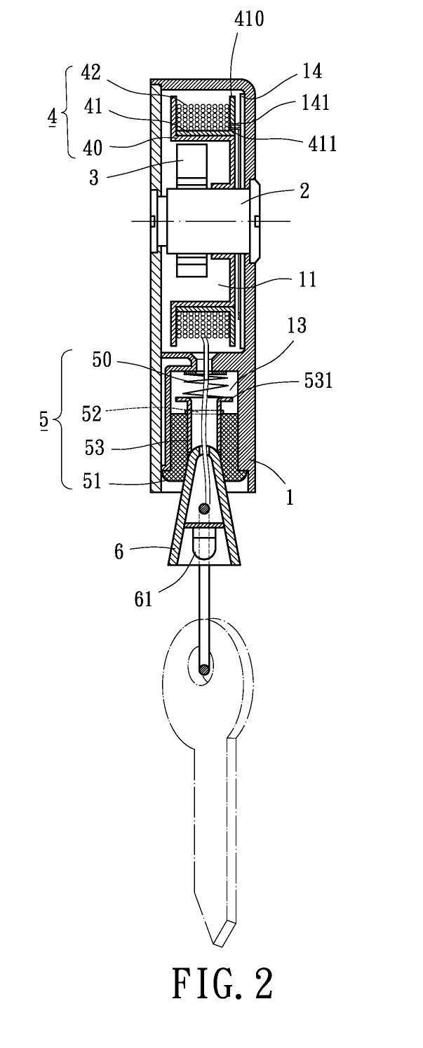

Referring to FIGS. 1 and 2, a reel device in accordance with the present invention comprises a housing 1, a positioning member 2, a return spring 3, an extendible unit 4, an internal control unit 5, and an external control member 6. The housing 1 includes a first compartment 11, at lease one second compartment 12, a third compartment 13, and a circuit board 14. The first compartment 11 is substantially circular in section and the positioning member 2 is mounted in a center of the first compartment 11 to allow easy installation of the return spring 3 and the extendible unit 4. The second compartment 12 is preferably annular for receiving at least one cell 120. The third compartment 13 is adjacent to and in communication with the first compartment 11 via a channel (not labeled). The internal control unit 5 is mounted in the third compartment 13. The circuit board 14 is formed on an inner wall of the housing 1 and includes at least two conductive rings 141.

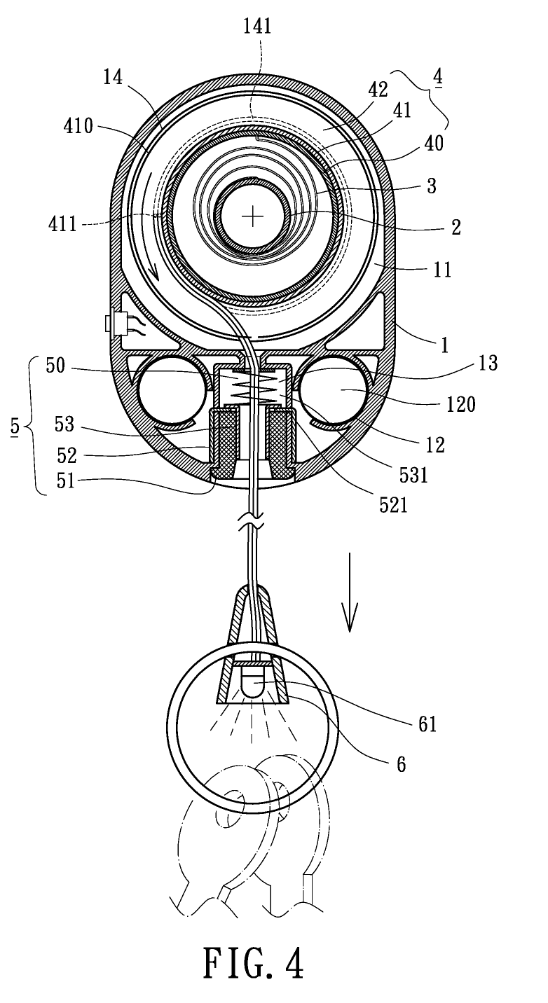

Still referring to FIGS. 1 and 2, the return spring 3 is mounted around the positioning member 2. An end of the return spring 3 is attached to an outer circumference of the positioning member 2. The extendible unit 4 includes a rotational ring 40, a connecting ring 41, and a wire 42 that are coiled concentrically around the positioning member 2 in sequence. The other end of the return spring 3 is attached to an inner circumference of the rotational ring 40. The connecting ring 41 includes an annular board 410. Further, the connecting ring 41 has an inner circumference coupled with an outer circumference of the rotational ring 40. The wire 42 is coiled in a coiling space defined by the annular board 410. The wire 42 extends through the annular board 410 and includes at least two terminals 411 for respective electrical connection with the conductive rings 141 (see FIG. 4). The rotational ring 40 and the connecting ring 41 may be integrally formed as a single member, allowing the rotational ring 40 and the connecting ring 41 to turn or rest synchronously.

Still referring to FIGS. 1 and 2, the internal control unit 5 includes at least one elastic element 50, an abutting member 51, a fixed conductive member 52, a movable conductive member 53, and a switch 54. The elastic element 50 is mounted between an inner wall of the third compartment 13 and the movable conductive member 53 and located adjacent to the channel. The abutting member 51 is a hollow annular member preferably made of soft material such as rubber to allow elastomeric deformation.

The fixed conductive member 52 and the movable conductive member 53 are preferably made of materials with excellent electric conductivity such as iron or copper. The fixed conductive member 52 is fixed to an outer wall of the abutting member 51 and includes a flange 521 on an end thereof for electrical contact with the movable conductive member 53. The movable conductive member 53 is substantially a hollow member having a flange 53 on an end thereof for releasable electrical contact with the fixed conductive member 52. The other end of the elastic element 50 abuts against the flange 53. An outer diameter of the movable conductive member 53 is slightly smaller than an inner diameter of the abutting member 51, allowing the other end of the movable conductive member 53 to be inserted into the abutting member 51 and movable along the inner wall of the abutting member 51 in a longitudinal direction of the abutting member 51. Further, the flange 531 of the movable conductive member 53 prevents the movable conductive member 53 from disengaging from or getting stuck in the abutting member 51. The other end of the wire 42 extends in sequence through the elastic element 50, the movable conductive member 53, and the abutting member 51 to an exterior of the housing 1.

Still referring to FIGS. 1 and 2, the external control member 6 includes an illuminating element 61 mounted therein. Preferably, the external control member 6 is conic and has a maximum diameter larger than an inner diameter of the abutting member 51, preventing the external control member 6 from getting stuck in the abutting member 51. The illuminating element 61 is mounted in an appropriate position in the external control member 6. The external control member 6 includes an opening (not labeled) in an end thereof through which the other end of the wire 42 extends. The illuminating element 61 is in electrical connection with the wire 42. Preferably, the illuminating element 61 is an LED (light-emitting diode) or a small light.

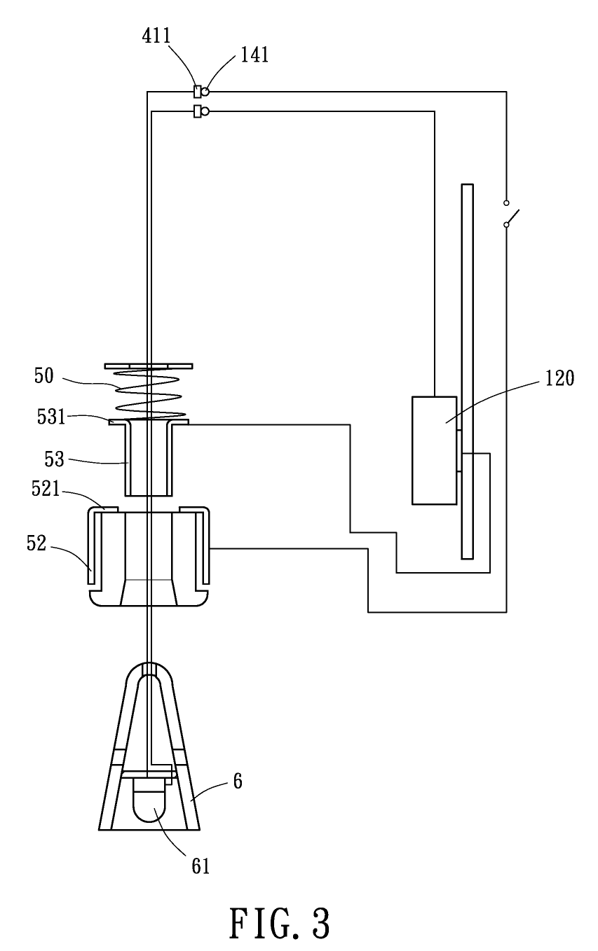

FIG. 3 shows a schematic circuitry diagram of the reel device in accordance with the present invention. The cell 120 supplies electricity to the illuminating element 61 for illuminating purposes. An electrode (not labeled) of the cell 120 is connected to the terminals 411 and a conductive ring 141 and then to an associated electrode of the illuminating element 61. The other electrode of the cell 120 is connected to the movable conductive member 53 and then to the other conductive ring 141 as well as the other electrode of the illuminating element 61. The fixed conductive member 52 forms a contact, and the flange 531 of the movable conductive member 53 is in selective contact with the flange 521 of the fixed conductive member 52. By such an arrangement, the illuminating element 61 is turned on when the flange 531 of the movable conductive member 53 comes in contact with the flange 521 of the fixed conductive member 52, and the illuminating element 61 is off when the flange 531 of the movable conductive member 53 disengages from the flange 521 of the fixed conductive member 52.

Referring to FIGS. 1 and 3, when not in use, the external control member 6 abuts against the inner wall of the abutting member 5, and the return spring 3 moves the external control member 6 inward via the wire 42. Thus, the external control member 6 presses the movable conductive member 53 inward. At this time, since the elastic bias provided by the return spring 3 is larger than that of the elastic element 50, the movable conductive member 53 moves inward and compresses the elastic element 50 while disengaging the movable conductive member 53 from the fixed conductive member 52. Thus, the illuminating element 61 is not turned on.

Referring to FIGS. 3 and 4, when in use, the external control member 6 is pulled outward away from the abutting member 51. The returning force of the elastic element 50 urges the movable conductive member 53 to move outward. Thus, the flange 531 of the movable conductive member 53 comes in contact with the flange 521 of the fixed conductive member 52, turning on the illuminating element 61. Meanwhile, the connecting ring 41 and the rotational ring 40 turn when the wire 42 is pulled outward together with the external control member 6, and the return spring 3 is in tension. When the external control member 6 is released, the returning force of the return spring 3 returns the wire 42 and the external control member 6 until the wire 42 coils around the connecting ring 41 again and the external control member 6 abuts against the abutting member 51 of the inner control unit 5 again.

By such an arrangement, the reel device with an illuminating element in accordance with the present invention can be used in the night or a dark environment, providing wider application.

Furthermore, the switch 54 may be provided for controlling open/closed circuit. More specifically, the switch 54 can be switched between a first position forming a closed circuit to allow on/off of the illuminating element 61 and a second position forming an open circuit in which the illuminating element 61 cannot be turned on even though the flange 531 of the movable conductive member 53 comes in contact with the flange 521 of the fixed conductive member 52. This avoids waste of electricity when using the reel device in a bright environment.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A reel device comprising:
an extendible unit including a wire;
a return spring for returning the extendible unit;
an internal control unit including a fixed conductive member and a movable conductive member;
at least one cell electrically connected via the internal control unit to an end of the wire; and
an external control member including an illuminating element mounted therein, the illuminating element being electrically connected to the other end of the wire;
wherein the movable conductive member comes in contact with the fixed conductive member when the external control member is pulled outward and thus carries the wire outward, and the illuminating element is turned on.

2. The reel device as claimed in claim 1, further comprising a housing including a first compartment for receiving a positioning member and the return spring, the return spring being mounted between the positioning member and the extendible unit.

3. The reel device as claimed in claim 2, wherein the extendible unit comprises a rotational ring and a connecting ring, the return spring having an end attached to the rotational ring, the connecting ring being mounted around the rotational ring, the wire being wound around the connecting ring.

4. The reel device as claimed in claim 3, wherein the connecting ring comprises an annular board having at least two terminals electrically connected to an end of the wire.

5. The reel device as claimed in claim 4, further comprising a circuit board formed on an inner wall defining the first compartment of the housing, the circuit board including at least two conductive rings respectively connected to said at least two terminals for respective electrical connection with said at least one cell and the illuminating element.

6. The reel device as claimed in claim 2, wherein the housing further comprises at least one second compartment for receiving said at least one cell.

7. The reel device as claimed in claim 2, wherein the housing further comprises another compartment for receiving the internal control unit.

8. The reel device as claimed in claim 7, wherein the first compartment is in communication with the compartment for receiving the internal control unit via a channel through which the wire extends.

9. The reel device as claimed in claim 8, further comprising at least one elastic element between an inner wall defining the third compartment and the movable conductive member of the internal control unit.

10. The reel device as claimed in claim 1, wherein the internal control unit further comprises an abutting member having an inner wall to which the external control member abuts and along which the movable conductive member moves.

11. The reel device as claimed in claim 10, wherein the external control member is conic and has a maximum diameter larger than an inner diameter of the abutting member.

12. The reel device as claimed in claim 1, wherein each of the movable conductive member and the fixed conductive member includes a flange for mutual electrical connection.

13. The reel device as claimed in claim 1, further comprising a switch for controlling on/off of the illuminating element.
